(19) United States
(12) Patent Application Publication
(10) Pub. No.: US 2023/0155116 A1
(43) Pub. Date: May 18, 2023

(54) ENERGY STORAGE DEVICES

(71) Applicant: FastCAP Systems Corporation, Wakefield, MA (US)

(72) Inventors: Wanjun Ben Cao, Boston, MA (US); Nicolo Brambilla, Brookline, MA (US); Ji Chen, Malden, MA (US); Kitae Park, Chestnut Hill, MA (US); Jin Yan, Boston, MA (US); Susheel KALABATHULA, Ashland, MA (US); Wyatt ANDREE, Revere, MA (US); Ting Du, Quincy, MA (US); Xujie Chen, Quincy, MA (US)

(21) Appl. No.: 17/986,077

(22) Filed: Nov. 14, 2022

Related U.S. Application Data
(60) Provisional application No. 63/278,782, filed on Nov. 12, 2021.

(51) Int. Cl. H01M 4/36; H01M 4/62; H01M 4/587; H01M 4/38

(52) U.S. Cl. CPC H01M 4/366; H01M 4/386; H01M 4/587; H01M 4/622; H01M 2004/027

(57) ABSTRACT

Disclosed herein is an anode, comprising an active layer comprising a network of high aspect ratio carbon elements defining void spaces within the network; a plurality of electrode active material particles disposed in the void spaces within the network, wherein the active material particles comprise silicon; and a polymeric additive, the polymeric additive being at least one of (i) selected from a family of polyamides, or (ii) a modified polyamide or derivative of a polyamide. Disclosed herein too is a cathode, comprising an active layer comprising a network of high aspect ratio carbon elements defining void spaces within the network; a plurality of electrode active material particles disposed in the void spaces within the network; and a polymeric additive, the polymeric additive being at least one of (i) selected from a family of polyamides, or (ii) a modified polyamide or derivative of a polyamide.

### CROSS REFERENCE TO RELATED APPLICATIONS

This application claims the benefit of U.S. Provisional Application Serial No. 63/278,782, filed Nov. 12, 2021, the entire disclosure of which is incorporated herein by reference.

### FIELD OF THE INVENTION

This invention relates to an energy storage device, particularly to ultracapacitors and lithium ion batteries, and to the electrodes used therein.

### BACKGROUND OF THE INVENTION

Lithium batteries are used in many products including medical devices, electric cars, airplanes, and consumer products such as laptop computers, cell phones, and cameras. Due to their high energy densities, high operating voltages, and low-self discharges, lithium ion batteries have overtaken the secondary battery market and continue to find new uses in products and developing industries.

Generally, lithium ion batteries (“LIBs” or “LiBs”) comprise an anode, a cathode, and an electrolyte material such as an organic solvent comprising a lithium salt. More specifically, the anode and cathode (collectively, “electrodes”) are formed by mixing either an anode active material or a cathode active material with a binder and a solvent to form a paste or slurry which is then coated and dried on a current collector, such as aluminum or copper, to form a film on the current collector. The anodes and cathodes are then layered or coiled prior to being housed in a pressurized casing containing an electrolyte material, which all together forms a lithium ion battery.

The binder serves to adhere the active materials to the current collector in a suitable coating. It is important that the binder facilitate maintenance sufficient contact of the active material with the current collector. Further, it has been important to select a binder that is mechanically compatible with the electrode active material(s) such that it is capable of withstanding the degree of expansion and contraction of the electrode active material(s) during charging and discharging of the battery. The binder must also be sufficient to withstand the manipulation of the electrode as it is fit into the battery casing.

Accordingly, binders such as cellulosic binder or cross-linked polymeric binders have been used to provide good mechanical properties. However, in conventional electrodes, binders selected generally require environmentally unfriendly or toxic solvents for processing.

### SUMMARY

Disclosed herein is an anode, comprising an active layer comprising a network of high aspect ratio carbon elements defining void spaces within the network; a plurality of electrode active material particles disposed in the void spaces within the network, wherein the active material particles comprises silicon; and a polymeric additive, the polymeric additive being at least one of (i) selected from a family of polyamides, or (ii) a modified polyamide or derivative of a polyamide.

Disclosed herein too is a cathode, comprising an active layer comprising a network of high aspect ratio carbon elements defining void spaces within the network; a plurality of electrode active material particles disposed in the void spaces within the network; and a polymeric additive, the polymeric additive being at least one of (i) selected from a family of polyamides, or (ii) a modified polyamide or derivative of a polyamide.

### BRIEF DESCRIPTION OF THE FIGURES

The following is a brief description of the drawings wherein like elements are numbered alike and which are presented for the purposes of illustrating the exemplary embodiments disclosed herein and not for the purposes of limiting the same.

FIG. 1 is a diagram of an example of an electrode as disclosed herein;

FIG. 2A is a flow chart showing an example of a method that can be used to make the electrode disclosed herein;

FIG. 2B is a flow chart that depicts an exemplary method of manufacturing an anode for an energy storage device;

FIG. 3 is a depiction of the electrode arrangement in pouch cell devices; and

FIG. 4 is a depiction of a schematic cutaway diagram showing aspects of an energy storage device (ESD).

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

Disclosed herein is an electrolytic cell that comprises a housing that comprises electrodes (an anode and a cathode). The housing comprises an electrolyte that contacts the anode and the cathode. Both of the electrodes (the anode and the cathode) comprise a current collector upon which is disposed an active layer. The active layer may be disposed upon an optional adhesive layer that contacts the electrode.

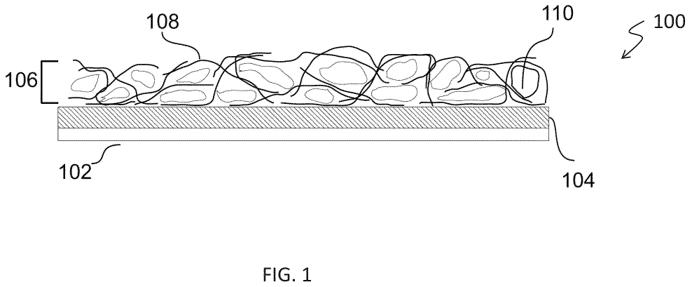

FIG. 1 is a diagram of one example of an electrode (an anode or a cathode) as disclosed herein. In the example shown, electrode 100 comprises current collector 102 and active layer 106. Electrode 100 may optionally include an adhesion layer 104. As an example, adhesion layer 104 comprises a material that promotes adhesion between current collector 102 and active layer 106. The active layer 106 comprises electrode active material 110 in a binder, and electrically conductive elements 108. The electrically conductive elements can comprise high aspect ratio elements.

The current collector 102 is an electrically conductive element. The current collector can comprise a metal (e.g., substantially pure metal or a metal alloy) As another example, current collector 102 can be in the form of a metal strip or metal foil. For example, the current collector 102 can be an aluminum foil or strip, an aluminum alloy foil or strip, a copper foil or strip, or a copper alloy foil or strip. Current collector 102 can have a thickness of no greater than 15 µm (microns), no greater than 10 µm, no greater than 8 µm or no greater than 5 µm. In some embodiments, at the same time the current collector can have a thickness of at least 3 µm. For example, the current collector 102 can have a thickness of 3 to 15 µm, preferably 6 µm to 10 µm. As another example, the current collector 102 is an aluminum foil or an aluminum alloy foil, having a thickness a thickness of 5 to 7 µm.

The active layer 106 comprises an electrically conductive material, a binder material, and an electrode active material. The active layer can be manufactured by mixing the electrically conductive material, the binder material, and the electrode active material with a solvent to form a mixture. The mixture can be applied directly to the current collector directly or onto an adhesive layer which can be adhered to the current collector. If an adhesive layer is used it can be electrically conductive. The mixture can be dried to remove the solvent leaving behind a solid active layer. The active layer 106 for the anode and the cathode will now be detailed separately.

The binder material for both the anode active layer and the cathode active layer are polyamides, preferably water soluble or alcohol soluble polyamides. The active material for the anode comprises silicon, while the active material for the cathode is Anode

As noted above, the anode comprises electrically conductive elements, a binder and an electrode active material that are mixed together to form a mixture. The mixture is disposed on the current collector and dried to form the active layer. Each of the ingredients of the anode active material layer are detailed below.

The electrically conductive elements (also referred to as electrically conductive material) can comprise carbon. For example, the conductive elements can be high aspect ratio carbon elements. The term “high aspect ratio carbon elements” refers to carbonaceous elements having a size in one or more dimensions (the “major dimension(s)”) significantly larger than the size of the element in a transverse dimension (the “minor dimension”). The high aspect ratio carbon elements can comprise a substantially cylindrical network of carbon atoms. The electrically conductive material can comprise carbon nanotubes or a plurality of bundles of carbon nanotubes.

In an embodiment, the electrically conducting material used in the anode may include graphite flakes. This is described later.

The electrically conductive material can form an electrically conducting percolating network (also referred to herein as a network of high aspect ratio carbon elements) that can transmit an electrical current between any two separated points located on a surface of the solid active layer (without the solvent in it). In other words, an electrical current can be transmitted from one surface or end to an opposing surface or end of the active layer by virtue of physical contacts or electron hopping between the electrically conductive elements in the electrode active layer. The percolating network can comprise voids between the high aspect ratio carbon elements that can contain or house the electrode active materials. The high aspect ratio electrically conductive material can be substantially oriented in the electrode active layer 106 in a direction substantially parallel to the current collector to facilitate conducting electrical current from one end of the electrode to the other while still maintaining some lesser orientation through the thickness of the active layer.

The network of high aspect ratio carbon elements comprises a first set of carbon nanotubes, wherein the first set of carbon nanotubes comprise a plurality of first carbon nanotubes or a plurality of bundles of first carbon nanotubes; and a second set of carbon nanotubes, wherein the second set of carbon nanotubes comprise a plurality of second carbon nanotubes or a plurality of bundles of second carbon nanotubes; and the second set of carbon nanotubes has one or more properties different from the first set of carbon nanotubes. In an embodiment, the first set of carbon nanotubes comprises multi-wall nanotubes and the second set of carbon nanotubes comprises single wall nanotubes; and a ratio of an amount by weight of the first set of carbon nanotubes to the second set of carbon nanotubes is about 2:1.

In an embodiment, a first average aspect ratio of the first set of carbon nanotubes is larger than a second average aspect ratio of the second set of carbon nanotubes. In another embodiment, the network of high aspect ratio carbon elements comprises a plurality of multi-wall carbon nanotubes and a distribution of lengths of the plurality of multi-wall carbon nanotube is skewed towards a nominal length a multi-wall carbon nanotube. In another embodiment, the nominal length of the multi-wall carbon nanotube is at least 15 micrometers.

In yet another embodiment, the network of high aspect ratio carbon elements comprises a plurality of multi-wall carbon nanotubes and at least 50% of the plurality of multi-wall carbon nanotubes have a length greater than 8 micrometers. In yet another embodiment, the network of high aspect ratio carbon elements comprises a plurality of multi-wall carbon nanotubes and at least 50% of the plurality of multi-wall carbon nanotubes have a length greater than 12 micrometers. In an embodiment, the first set of carbon nanotubes swell more than the second set of carbon nanotubes when both are swelled by an electrolyte.

The electrically conductive material can be present in the mixture in amounts of 0.1 to 2.0, or 0.15 to 1.2, or 0.3 to 1 weight percent (wt%), based on the total weight of the mixture (the mixture comprises the electrically conductive material, the electrode active material, the binder material and a solvent). The electrically conductive material can be present in the active layer in amounts of 0.2 to 3.5, or 0.3 to 3, or 0.5 to 2 weight percent based on total weight of solids in the active layer (total weight solids comprises electrically conductive material, the binder material, the electrode active material without the solvent).

The high aspect ratio carbon elements can be single wall carbon nanotubes (SWCNTs), double wall carbon nanotubes (DWNTs), multiwall carbon nanotubes (MWNTs), or a mixture of both.

The single wall carbon nanotubes can have an outer diameter of 0.5 to 5.0 nanometers, preferably 1.0 to 3.5 nanometers. The single wall carbon nanotubes can have an aspect ratio (length to diameter ratio) greater than about 2.0, preferably greater than 5.0, preferably greater than 10.0, greater than 50 and more preferably greater than 100. In an exemplary embodiment, the single wall carbon nanotubes can have an average aspect ratio of 5 to 200.

The single wall carbon nanotubes can have a length greater than 6 nanometers, preferably greater than 10 nanometers, preferably greater than 15 nanometers, preferably greater than 30 nanometers, preferably greater than 50 nanometers, more preferably greater than 100 nanometers, preferably greater than 1 micrometer, preferably greater than 5 micrometers, preferably greater than 10 micrometers, and more preferably greater than 15 micrometers up to at least 200 micrometers. In an exemplary embodiment, the single wall carbon nanotubes can have an average length of 10 nanometers to 20 micrometers, preferably 20 nanometers to 15 micrometers.

The single wall carbon nanotubes can present in the mixture of electrically conductive material, binder material, electrode active material and solvent in an amount of 0.1 to 0.3 weight percent, preferably 0.15 to 0.25 weight percent based on the total weight of the mixture.

The single wall carbon nanotubes are present in the electrode active layer (electrically conductive material, binder material, and electrode active material without the solvent) in an amount of 0.2 to 0.6 wt%, preferably 0.3 to 0.5 wt%, based on the entire weight of the electrode active layer.

The number of carbon walls in the multi-wall carbon nanotubes can be 2 or more, 5 or more, 10 or more, 50 or more. The multi-wall carbon nanotubes can comprise an average of between 3 layers to 15 layers, 4 to 12 layer, 5 to 10 layers, 6 to 8 layers.

The active layer 106 can comprise multi-wall carbon nanotubes and single-wall carbon nanotubes. The multi-wall carbon nanotubes swell more than single-wall carbon nanotubes when wetted with an electrolyte in an energy storage device in which electrode 100 is located. For example, the multi-wall carbon nanotubes can swell at least 15%, or at least 25% or at least 50% more than single-wall carbon nanotubes when wetted with an electrolyte in an energy storage device in which electrode 100 is located. For example, a length of the multi-wall carbon nanotubes can expand at least 15%, or at least 25% or at least 50% more than a length of the single-wall carbon nanotubes when wetted with the electrolyte. As another example, the multi-wall carbon nanotubes swell up to 50% when wetted (e.g., a length of the multi-wall carbon nanotubes is 50% larger after wetting with an electrolyte, and/or a diameter of the multi-wall carbon nanotubes is 50% larger after wetting, etc.).

The multi-wall carbon nanotubes can have an outer diameter of 2.0 to 50 nanometers, 5.0 to 40 nanometers, or 6 to 10 nanometers. The multi-wall carbon nanotubes can have a length greater than 10 nanometers, greater than 15 nanometers, greater than 30 nanometers, greater than 50 nanometers, greater than 100 nanometers, greater than 500 nanometers, greater than 1 micrometer, greater than 5 micrometers, greater than 10 micrometers, or greater than 15 micrometers. At the same time the multi-wall carbo nanotubes can have an average length up to 25 micrometers or up to 20 micrometers. In exemplary embodiments, the multi-wall carbon nanotubes have an average length of 10 nanometers to 20 micrometers, or 20 nanometers to 15 micrometers. The multi-wall carbon nanotubes can have an aspect ratio (length to diameter ratio) greater than 5.0, greater than 10.0, greater than 50, greater than 100, or greater than 500. In an embodiment, the multi-wall carbon nanotubes can be branched nanotubes.

The electrode comprises multi-wall carbon nanotubes can be relatively longer in comparison to multi-wall carbon nanotubes comprised in related art electrodes. The use of relatively longer multi-wall carbon nanotubes in electrodes is found to have beneficial mechanical and/or electrical properties. For example, multi-wall carbon nanotubes provide relatively good power at low densities. As another example, shorter multiwall carbon nanotubes generally do not swell (e.g., expand) as much as longer multiwall carbon nanotubes. As such use of shorter multi-wall carbon nanotubes loses (or reduces) some of the beneficial properties associated with swelling of the carbon nanotubes. As an extreme example, carbon black does not exhibit swelling because carbon black is merely particles of carbon without entanglement such as the entanglement exhibited by a set of multi-wall carbon nanotubes. An indication that a length of a certain amount of multi-wall carbon nanotubes have a length exceeding a threshold length and thus have sufficient swelling properties is an observation during a calendering process - a relatively larger amount of pressure or effort to calendar the slurry in connection with applying to the foil is indicative that the collective swelling (e.g., an average swelling) of the multi-wall carbon nanotubes in the active layer will satisfy a certain performance threshold. However, multi-wall carbon nanotubes are generally difficult to process.

The processing of the multi-wall carbon nanotubes in connection with preparing/forming the active layer and/or electrode is gentler than processes for related art electrodes. As such, the processes according to various embodiments maintain longer multi-wall carbon nanotubes (e.g., less multi-wall carbon nanotubes are crushed, fragmented, broken, etc.). In some embodiments, the active layer of the electrode comprises a set of multiwall carbon nanotubes having an average length that is more an average length of the multiwall carbon nanotubes in related art electrodes. According to various embodiments, a distribution of lengths of the set of multi-wall carbon nanotubes is skewed towards a nominal length a multi-wall carbon nanotube. As an example, the nominal length of a multi-wall carbon nanotube is about 16 microns. For example, the multi-wall carbon nanotubes are processed and/or applied in a manner that reduces or minimizes fracturing or breaking of multi-wall carbon nanotubes. The lengths of the multi-wall carbon nanotubes in the network of high aspect ratio carbon elements are generally the nominal length of the multi-wall carbon nanotubes, or a length of such the multi-wall carbon nanotubes tend to be more heavily skewed to the nominal length. In some embodiments, at least 75% of the multi-wall carbon nanotubes within the network of high aspect ratio carbon elements are within 10% of the nominal length (e.g., between 13.4 microns to about 15 microns). In some embodiments, at least 75% of the multi-wall carbon nanotubes within the network of high aspect ratio carbon elements have a length of at least 12 microns. In some embodiments, at least 75% of the multiwall carbon nanotubes within the network of high aspect ratio carbon elements have a length of at least 13 microns. In some embodiments, at least 50% of the multi-wall carbon nanotubes within the network of high aspect ratio carbon elements are within 10% of the nominal length (e.g., between 13.4 microns to about 15 microns). In some embodiments, at least 50% of the multi-wall carbon nanotubes within the network of high aspect ratio carbon elements have a length of at least 12 microns. In some embodiments, at least 50% of the multiwall carbon nanotubes within the network of high aspect ratio carbon elements have a length of at least 8 microns. In some embodiments, at least 50% of the multi-wall carbon nanotubes within the network of high aspect ratio carbon elements have a length of at least 13 microns.

According to various embodiments, a distribution of lengths of the set of multi-wall carbon nanotubes is skewed towards a nominal length a multi-wall carbon nanotube. For example, the multi-wall carbon nanotubes are processed and/or applied in a manner that reduces or minimizes fracturing or breaking of multi-wall carbon nanotubes. The lengths of the multi-wall carbon nanotubes in the network of high aspect ratio carbon elements are generally the nominal length of the multi-wall carbon nanotubes, or a length of such the multi-wall carbon nanotubes tend to be more heavily skewed to the nominal length.

In some embodiments, at least 75% of the multiwall carbon nanotubes within the network of high aspect ratio carbon elements are within 10% of the nominal length (e.g., between 13.4 micrometers to about 15 micrometers). In some embodiments, at least 75% of the multi-wall carbon nanotubes within the network of high aspect ratio carbon elements have a length of at least 12 micrometers. In some embodiments, at least 75% of the multi-wall carbon nanotubes within the network of high aspect ratio carbon elements have a length of at least 13 micrometers. In some embodiments, at least 50% of the multi-wall carbon nanotubes within the network of high aspect ratio carbon elements are within 10% of the nominal length (e.g., between 13.4 micrometers to about 15 micrometers). In some embodiments, at least 50% of the multi-wall carbon nanotubes within the network of high aspect ratio carbon elements have a length of at least 12 micrometers. In some embodiments, at least 50% of the multiwall carbon nanotubes within the network of high aspect ratio carbon elements have a length of at least 13 micrometers.

The multi-wall carbon nanotubes can be present in the mixture (the mixture comprises the electrically conductive material, the electrode active material, the binder material and a solvent or a combination of solvents) in an amount of 0.3 to 1.0 weight percent, preferably 0.4 to 0.9 weight percent based on the total weight of the mixture. The multi-wall carbon nanotubes are present in the solid anode active layer (the solid active layer comprises the electrically conductive material, the binder material, the electrode active material without the solvent) in an amount of 0.8 to 2.6 wt%, preferably 1.0 to 1.8 wt%, based on the entire weight of the solid anode active material.

In an example where both multi-wall and single wall carbon nanotubes are used, the ratio of the weight of the multi-wall carbon nanotubes to the weight of the single wall carbon nanotubes in the mixture or in the solid active material layer can be at least 2:1.

In one example, three-dimensional network of high aspect ratio carbon elements 108 comprises carbon nanotubes, and the carbon nanotubes are only multi-wall carbon nanotubes and/or fragments of such carbon nanotubes.

In another example, the multiwall carbon nanotubes are present in the mixture or in the solid anode active material layer in an amount that is at least twice the amount of the single wall carbon nanotubes, based on the weight of the conductive materials.

The network of three-dimensional network of high aspect ratio carbon elements 108 can comprise at least 99% carbon by weight.

In addition to the high aspect ratio carbon elements (the carbon nanotubes), the electrically conductive materials may optionally comprise graphite flakes, carbon black, or a combination thereof.

The graphite flakes are preferably high aspect ratio graphite flakes where at least one dimension is larger than any other dimension. The graphite flakes may be naturally occurring or commercially synthesized flakes. The graphite flakes are particulate like and may be ellipsoidal in shape. The aspect ratio of these graphite flakes may range from 2:1 to 20:1, preferably 5:1 to 12:1. In an embodiment, the graphite flakes may be intercalated with metal ions. In another embodiment, the graphite flakes may be exfoliated flakes.

The graphite flakes may be present in the solid anode active layer (the solid active layer comprises the electrically conductive material, the binder material, the electrode active material without the solvent) in an amount of 5 to 65 wt%, preferably 8 to 50 wt%, based on the entire weight of the solid anode active material.

Carbon black may also be used in addition to the carbon nanotubes. The carbon black is typically a high surface area carbon black that has a surface area of greater than 50 square meters per gram (m2/gm), preferably greater than 200 m2/gm, and more preferably greater than 500 m2/gm. An example of a high surface area carbon black is KELTJEN Black. The carbon black is optional and may be present in the solid anode active layer (the solid active layer comprises the electrically conductive material, the binder material, the electrode active material without the solvent) in an amount of 0.5 to 2.0 wt%, preferably 0.8 to 1.6 wt%, based on the entire weight of the solid anode active material.

The three-dimensional network of high aspect ratio carbon elements 108 can comprise an electrically interconnected network of carbon elements exhibiting connectivity above a percolation threshold and wherein the network defines one or more highly electrically conductive pathways having a length greater than 100 µm. The percolation threshold is one where the conducting elements contact one another to provide an electrically conducting network measured across any two points on any surface of the network.

### Anode Binder

In an embodiment, the anode active layer comprises a polymeric binder that comprises a nylon (i.e., a polyamide), the family of polyamides, or derivatives of polyamide. In an exemplary embodiment, the polyamide is a water soluble polyamide, an alcohol soluble polyamide, or a combination thereof (i.e., soluble in a combination of water and alcohol). The anode active layer does not include a polymeric material that is non-soluble in water or an alcohol. In other words, the anode active layer does not contain a polyamide or any other polymeric binder that is not water soluble.

The polyamides (used in the anode and the cathode polymeric binder) can include aliphatic polyamides, aromatic polyamides, or a combination thereof. In one embodiment, the polyamides include a generic family of resins known as nylons, characterized by the presence of an amide group (—C(O)NH—). Any amide-containing polymers can be employed, individually or in combination: Nylon-6 and nylon-6,6 are suitable polyamide resins available from a variety of commercial sources. Other polyamides, however, such as nylon-4, nylon-4,6 (PA 46), nylon-12, nylon-6,10, nylon-6,9, nylon-6,12, nylon-9T, copolymer of nylon-6,6 and nylon-6, nylon 610 (PA610), nylon 11 (PA11), nylon 12 (PA 12), nylon 6-3-T (PA 6-3-T), polyarylamid (PA MXD 6), polyphthalamide (PPA) and/or poly-ether-block amide, and others such as the amorphous nylons, may also be useful. Mixtures of various polyamides, as well as various polyamide copolymers, are also useful.

The polyamides can be obtained by a number of well-known processes such as those described in U.S. Pat. Nos. 2,071,250; 2,071,251; 2,130,523; 2,130,948; 2,241,322; 2,312,966; and 2,512,606. Nylon-6, for example, is a polymerization product of caprolactam. Nylon-6,6 is a condensation product of adipic acid and 1,6-diaminohexane. Likewise, nylon 4,6 is a condensation product between adipic acid and 1,4-diaminobutane. Besides adipic acid, other useful diacids for the preparation of nylons include azelaic acid, sebacic acid, dodecane diacid, as well as terephthalic and isophthalic acids, and the like. Other useful diamines include m-xylyene diamine, di-(4-aminophenyl)methane, di-(4-aminocyclohexyl)methane; 2,2-di-(4-aminophenyl)propane, 2,2-di-(4-aminocyclohexyl)propane, among others. Copolymers of caprolactam with diacids and diamines are also useful.

Polyamides are generally derived from the polymerization of organic lactams having from 4 to 12 carbon atoms. In one embodiment, the lactams are represented by the formula (1)

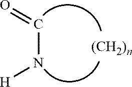

wherein n is 3 to 11 In one embodiment, the lactam is epsilon-caprolactam having n equal to 5

Polyamides may also be synthesized from amino acids having from 4 to 12 carbon atoms. In one embodiment, the amino acids are represented by the formula (II)

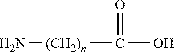

wherein n is 3 to 11. In one embodiment, the amino acid is epsilon-aminocaproic acid with n equal to 5. Polyamides may also be polymerized from aliphatic dicarboxylic acids having from 4 to 12 carbon atoms and aliphatic diamines having from 2 to 12 carbon atoms. In one embodiment, the aliphatic diamines are represented by the formula (III)

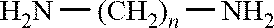

wherein n is about 2 to about 12. In one embodiment, the aliphatic diamine is hexamethylenediamine (H₂ N(CH))₆NH₂). In one embodiment, the molar ratio of the dicarboxylic acid to the diamine is from 0.66 to 1.5. Within this range it is generally beneficial to have the molar ratio be greater than or equal to 0.81. In another embodiment, the molar ratio is greater than or equal to 0.96. In yet another embodiment, the molar ratio is less than or equal to 1.22. In still another embodiment, the molar ratio is less than or equal to 1.04. Examples of polyamides that are useful in the present invention include nylon 6, nylon 6,6, nylon 4,6, nylon 6, 12, nylon 10 or combinations including at least one of the foregoing polyamides

The polyamide has a molecular weight greater than 200 g/mol, preferably greater than 500,000 g/mole, preferably greater than 1,000,000 g/mole, and more preferably 500,000 g/mole to 1,500,000 g//mole.

In an embodiment, the anode active layer comprises at least 0.5 wt%, preferably 0.5 to 1.5 wt% of the polymeric additive. The weight percent is based on a total weight of the active layer.

### Anode Active Material

In an embodiment, the anode comprises an active layer comprising a network of high aspect ratio carbon elements defining void spaces within the network; a plurality of electrode active material particles disposed in the void spaces within the network, wherein the active material particles comprises silicon; and a polymeric additive, the polymeric additive being at least one of (i) selected from a family of polyamides, or (ii) a modified polyamide or derivative of a polyamide.

In an embodiment, the silicon comprised in the electrode active material particles is in the form of SiO. The silicon comprised in the electrode active material is micro-silicon. In an embodiment, the silicon comprised in the electrode active material is greater than fifty percent of the active layer by weight. The silicon in the electrode active material is at least eighty percent of the active layer by weight.

### Summary of the Anode

In an embodiment, the anode comprises an active layer comprising a network of high aspect ratio carbon elements defining void spaces within the network; a plurality of electrode active material particles disposed in the void spaces within the network, wherein the active material particles comprises silicon; and a polymeric additive, the polymeric additive being at least one of (i) selected from a family of polyamides, or (ii) a modified polyamide or derivative of a polyamide.

In an embodiment, the silicon comprised in the electrode active material particles is in the form of SiO. The silicon comprised in the electrode active material is micro-silicon. In an embodiment, the silicon comprised in the electrode active material is greater than fifty percent of the active layer by weight. The silicon in the electrode active material is at least eighty percent of the active layer by weight.

The network of high aspect ratio carbon elements comprises a mesh of carbon nanotubes; and the mesh of carbon nanotubes maintains electrical connection among at least a subset of the carbon nanotubes comprised in the mesh during expansion of the silicon.

The network of high aspect ratio carbon elements comprises a mesh of carbon nanotubes; and the mesh of carbon nanotubes maintains electrical connection among at least a subset of the carbon nanotubes present in the mesh during a charging and discharging of a battery in which the electrode is comprised. The network of high aspect ratio carbon elements is detailed above and most of it will not be repeated herein in the interests of brevity. Some features of the network of high aspect ratio carbon nanotubes in the anode active layer which are different from the corresponding network present in the cathode will however, be detailed here.

In an embodiment, the network of high aspect ratio carbon elements contain graphite particles in the voids. The graphite is generally present in an amount of up to 10 wt%, preferably in an amount of up to 5 wt% in the anode active layer.

Multiwall carbon nanotubes (the first set of carbon nanotubes) are present in the anode active layer in an amount of at least 3 wt%, preferably at least 4.5 wt%, based on the weight of the anode active layer. In an embodiment, the multiwall carbon nanotubes are present in the anode active layer in an amount of 3 to 5 wt%, based on the weight of the anode active layer.

Single wall carbon nanotubes (the second set of carbon nanotubes) are present in the anode active layer in an amount of at least 1.5 wt%, preferably at least 2 wt%, based on the weight of the anode active layer.

In an embodiment, the weight of the first set of carbon nanotubes (multiwall carbon nanotubes (which include double wall carbon nanotubes)) to the weight of the second set of carbon nanotubes (single wall carbon nanotubes) is at least 5:1, preferably at least 9:1.

In an embodiment, the thickness of the active layer increases after being swelled by the electrolyte. In an embodiment, the active layer (of either the anode or the cathode) increases by an average thickness amount of less than 15% upon being wetted with the electrolyte (based on the initial dimensions prior to wetting with the electrolyte), preferably less than 10%, and preferably less than 5%.

The first average aspect ratio of the first set of carbon nanotubes is larger than a second average aspect ratio of the second set of carbon nanotubes. The average aspect ratio of the first set of carbon nanotubes is at least 100 to up to 1000, preferably 200 to 1000.

In an embodiment, the network of high aspect ratio carbon elements comprise a set of multi-wall carbon nanotubes comprising a plurality of multi-wall carbon nanotubes; the plurality of multi-wall carbon nanotubes have an average length greater than 5 microns, preferably greater than 10 micrometers.

In an embodiment, the energy storage device comprises an anode and a cathode, where the anode or cathode comprises an active layer that comprises a network of high aspect ratio carbon elements that contain a first set of carbon nanotubes that comprises multi-wall carbon nanotubes; a second set of carbon nanotubes that comprises single-wall carbon nanotubes; and further comprises graphite. The active layer shows that when wetted with the electrolyte the multi-wall nanotubes swell less than the single-wall carbon nanotubes.

The polymeric additive in the anode active layer is a polyamide, preferably a water soluble polyamide, an alcohol soluble polyamide, or a polyamide that is soluble in water and an alcohol. The polyamide is detailed below and will not be repeated here again.

The anode active layer has an average thickness of 20 microns to 100 micrometers, preferably 30 to 50 micrometers. The anode active layer comprises anode active particles (that contains silicon, such as, for example, a silicate) in an amount of 96 to 99 wt%, preferably 96 to 98.5 wt% of the anode active layers.

The anode active layer also comprises a surface treatment on the surface of the high aspect ratio carbon elements which promotes adhesion between the high aspect ratio carbon elements and the active material particles. The surface treatment can comprise a surfactant. The surfactant may be present in the active layer in an amount of at least 0.5 wt%, based on the weight of the active layer. The surfactant forms a surfactant layer that is bonded to the high aspect ratio carbon elements and comprises a plurality of surfactant elements each having a hydrophobic end and a hydrophilic end, wherein the hydrophobic end is disposed proximal a surface of one of the carbon elements and the hydrophilic end is disposed distal said surface of one of the carbon elements. The surface treatment may comprise the polymeric additive (i.e., it may be a polyamide).

The multi-wall carbon nanotubes may be substantially aligned in a direction perpendicular to the surface of the active layer or alternatively, perpendicular to a metal foil that is used as an electrode. The metal foil may comprise copper or aluminum.

In an embodiment, an energy storage device (i.e., an ultracapacitor or battery), comprises a cathode; an electrolyte; and an anode comprising an active layer comprising a network of high aspect ratio carbon elements defining void spaces within the network; a plurality of electrode active material particles disposed in the void spaces within the network wherein the active material particles comprises silicon; and a polymeric additive, the polymeric additive being at least one of (i) selected from a family of polyamides, or (ii) a modified polyamide or derivative of a polyamide, wherein the active layer comprises sufficient silicon that during a charging and discharging cycle at least a portion of the silicon is not used.

### Preparation of Anode

The anode can be produced by first preparing a mixture (sometime referred to as a slurry) of the electrically conductive elements, the active material and the binder in a solvent or solvent mixture. The method used to manufacture the anode can also be used to manufacture the cathode. The method will not be repeated again during the manufacturing of the cathode in the interests of brevity. An advantage of the binders as described herein is that a useful slurry can be formed using water, alcohol, or a combination thereof as the solvent. The slurry can then be coated directly onto a current collector or applied to a current collector with an intermediate adhesive layer.

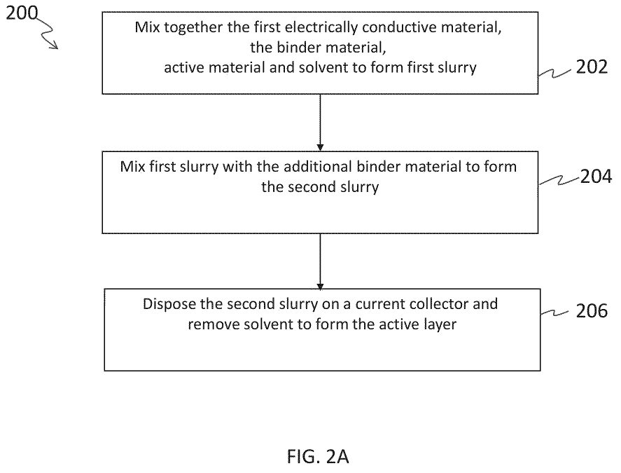

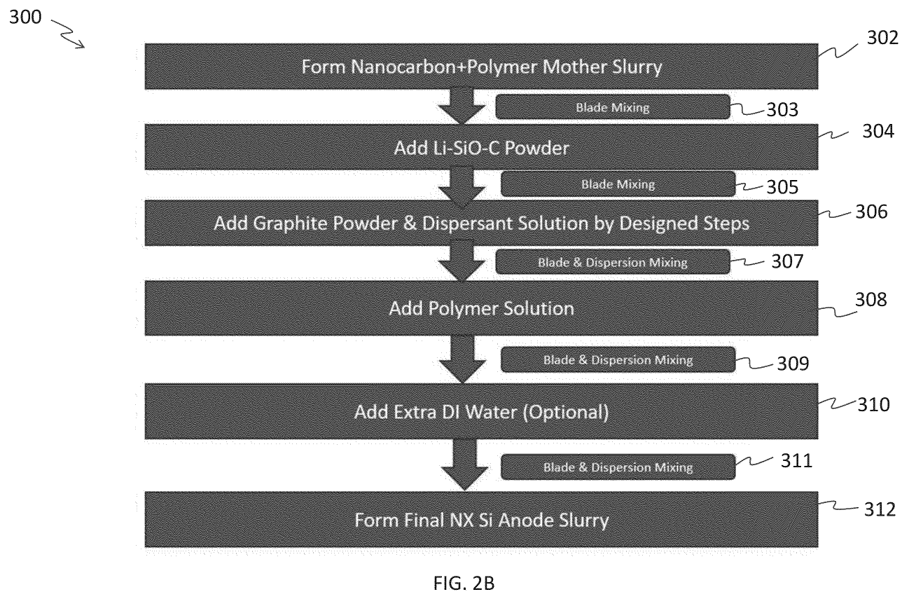

The slurry can be prepared in a single step. FIGS. 2A and 2B depict the process for manufacturing either an anode or a cathode. They depict the method of manufacturing the active layer for the anode and the cathode and applying the active layer to the current collector. Alternatively, the slurry can be prepared according to a multiple step process as shown in the flow chart of FIG. 2A describing an example of a process 200 to provide with respect to electrode 100 of FIG. 1. At 202, an electrically conducting material, e.g., high aspect ratio carbon elements, and a surface treatment material (e.g., a surfactant, the binder material as described herein, or both) are combined with a solvent (e.g., water, alcohol, or a combination thereof) to form an initial slurry. At 204, any additional binder may be added to the initial slurry to form a second slurry. At 206, the slurry is applied to a metal foil (the current collector). The solvent present in the slurry is removed via vacuum or heating to form the active layer on the current collector.

FIG. 2B depicts another method 300 of manufacturing the anode (or a cathode) for an energy storage device. At 302, an electrically conducting material, e.g., high aspect ratio carbon elements, and a surface treatment material (e.g., a surfactant, the binder material as described herein, or both) are combined with a solvent (e.g., water, alcohol, or a combination thereof) to form an initial slurry. The material may be mixed in a blade mixer 303.

At 304, the initial slurry is processed to ensure good dispersion of the solid materials in the slurry. A Li—SiO—C active material (or a NMC material) may be added to the slurry. Graphite powder and an optional dispersant may be added in step 306. Blade mixing may be conducted in mixing steps 305 and 307. A polymer solution may be added in step 308 and additional deionized water may be added in step 310. Blade and dispersion mixing may be used in steps 307 and 309. A slurry prepared in step 312 may then be added to the current collector.

This processing can include introducing mechanical energy into the mixture of solvent and solid materials (e.g., using a sonicator, which may sometimes also be referred to as a “sonifier”) or other suitable mixing device (e.g., a high shear mixer). For example, the mechanical energy introduced into the mixture can be at least 0.4 kilowatt-hours per kilogram (kWh/kg), 0.5 kWh/kg, 0.6 kWh/kg, 0.7 kWh/kg, 0.8 kWh/kg, 0.9 kWh/kg, 1.0 kWh/kg, or more. For example, the mechanical energy introduced into the mixture per kilogram of mixture may be in the range of 0.4 kWh/kg to 1.0 kWh/kg or any subrange thereof such as 0.4 kWh/kg to 0.6 kWh/kg.

As one example, an ultrasonic bath mixer may be used in steps 302, 304 or 306. As another example, a probe sonicator may be used. Probe sonication may be significantly more powerful and effective when compared to ultrasonic baths for nanoparticle applications. High shear forces created by ultrasonic cavitation have the ability to break up particle agglomerates and result in smaller and more uniform particles sizes. Among other things, sonication can result in stable and homogenous suspensions of the solids in the slurry. Generally, this results in dispersing and deagglomerating and other breakdown of the solids. Examples of probe sonication devices include the Q Series Probe Sonicators available from QSonica LLC of Newtown, Connecticut. Another example includes the Branson Digital SFX-450 sonicator available commercially from Thomas Scientific of Swedesboro, New Jersey.

The localized nature of each probe within the probe assembly can occasionally result in uneven mixing and suspension. Such may be the case, for example, with large samples. This may be countered by use of a setup with a continuous flow cell and proper mixing. For example, with such a setup, mixing of the slurry will achieve reasonably uniform dispersion.

The initial slurry, once processed can have a viscosity in the range of 5,000 cps to 25,000 cps or any subrange thereof, e.g., 6,000 cps to 19,000 cps.

At optional step, (used, for example, if the binder was not added in step 302) the binder or additional binder can be applied as a surface treatment may be fully or partially formed on the electrically conductive material (e.g., high aspect ratio carbon elements) in the initial slurry. In some embodiments, at this stage the surface treatment may self-assemble.

The resulting surface treatment can include functional groups or other features which, as described in further steps below, may promote adhesion between the high aspect ratio carbon elements and active material particles. For example, functional groups on the binder can provide the stated surface treatment.

At 304 and 306, the active material particles may be combined with the initial slurry to form a final slurry containing the active material particles along with the high aspect ratio carbon elements with the surface treatment formed thereon.

The active material may be added directly to the initial slurry. Alternatively, the active material may first be dispersed in a solvent (e.g., water, alcohol or a combination thereof using the techniques described above with respect to the initial solvent) to form an active material slurry. This active material slurry may then be combined with the initial slurry to form the final slurry.

Suitable solvents are water, alcohol, or a combination thereof. Examples of alcohol are ethanol, methanol, propanol, butyl alcohol, ethylene glycol, propylene glycol, or a combination thereof. In addition to water and alcohol, other solvents may be added to facilitate solubilization and/or dispersion of the polymer. Other solvents include polar solvents, non-polar solvents, and the like. The addition of other solvents should preferably not change the solubility of the polymer in the water or alcohol. Liquid aprotic polar solvents such as propylene carbonate, ethylene carbonate, butyrolactone, acetonitrile, benzonitrile, nitromethane, nitrobenzene, sulfolane, dimethylformamide, N- methylpyrrolidone, or the like, or combinations thereof may be added to water or alcohol for dissolution of the polymer. Polar protic solvents such acetonitrile, nitromethane, acetone, dimethyl sulfoxide, dimethylformamide, or the like, or a combination thereof may be used. Other non-polar solvents such a benzene, toluene, methylene chloride, carbon tetrachloride, hexane, diethyl ether, tetrahydrofuran, or the like, or a combination thereof may also be used. Co-solvents comprising at least one aprotic polar solvent and at least one non-polar solvent may also be utilized to modify the solubilization power of the solvent.

When water and alcohol are used as the solvents for the anode active layer (used in the anode) the ratio of water to alcohol is 80:20 to 95:5, preferably 88:12 to 92:8. In an exemplary embodiment, the ratio of water to alcohol is 90:10.

The solvent may be added to the mixture of the binder, the electrically conductive material and the active material in an amount of 10 to 1000 wt%, preferably 50 to 500 wt%, and more preferably 100 to 200 wt% of the total weight of the solids used to form the active layer. The solids include materials that do not evaporate and end up in the active material layer that is disposed on the current conductor (e.g., the binder, the electrically conductive material and the active material).

At 312, the final slurry is processed to ensure good dispersion of the solid materials in the final slurry. Any suitable mixing process known in the art may be used. For example, this processing may use the techniques described above with reference to 303, 305, 307, 309, and 311, and the like. Alternatively, a planetary mixer such as a multi-axis (e.g., three or more axis) planetary mixer can be used. The planetary mixer can feature multiple blades, e.g., two or more mixing blades and one or more (e.g., two, three, or more) dispersion blades such as disk dispersion blades.

During 312, the matrix enmeshing the active material may fully or partially self-assemble as interactions between the surface treatment (e.g., binder) and the active material promote the self-assembly process.

In some embodiments the final slurry, once processed will have a viscosity in the range of 1,000 cps to 10,000 cps or any subrange thereof, e.g., 2,500 cps to 6000 cps.

At 312, the active layer 106 is formed from the final slurry. In some embodiments, final slurry may be cast wet directly onto the current collector conductive layer 102 (or optional adhesion layer 104) and dried. As an example, casting may be by applying at least one of heat and a vacuum until substantially all of the solvent and any other liquids have been removed, thereby forming the active layer 106. Protecting various parts of the underlying layers may be desirable. For example, protecting an underside of the conductive layer 102 may be desirable where the electrode 100 is intended for single-sided operation. Protection may include, for example, protection from the solvent by masking certain areas, or providing a drain to direct the solvent away.

In another example, the final slurry may be at least partially dried elsewhere before being transferred onto the adhesion layer 104 or the conductive layer 102 to form the active layer 106, using any suitable technique (e.g., roll-to-roll layer application). As another example, the wet combined slurry may be placed onto an intermediate material with an appropriate surface and dried to form the layer (e.g., the active layer 106). While any material with an appropriate surface may be used as the intermediate material, exemplary intermediate material includes polytetrafluoroethylene (PTFE) as subsequent removal from the surface is facilitated by the properties thereof. The layer can be formed in a press to provide a layer that exhibits a desired thickness, area and density.

In yet another example, the final slurry may be formed into a sheet, and coated onto the adhesion layer 104 or the conductive layer 102 as appropriate. For example, the final slurry can be applied to through a slot die to control the thickness of the applied layer. As another example, the slurry may be applied and then leveled to a desired thickness, e.g., using a doctor blade. A variety of other techniques may be used for applying the slurry. For example, coating techniques may include, without limitation: comma coating; comma reverse coating; doctor blade coating; slot die coating; direct gravure coating; air doctor coating (air knife); chamber doctor coating; off set gravure coating; one roll kiss coating; reverse kiss coating with a small diameter gravure roll; bar coating; three reverse roll coating (top feed); three reverse roll coating (fountain die); reverse roll coating and others.

The viscosity of the final slurry may vary depending on the application technique. For example, for comma coating, the viscosity may range between about 1,000 cps to about 200,000 cps. Lip-die coating provides for coating with slurry that exhibits a viscosity of between about 500 cps to about 300,000 cps. Reverse-kiss coating provides for coating with slurry that exhibits a viscosity of between about 5 cps and 1,000 cps. In some applications, a respective layer may be formed by multiple passes.

Where desired, the active layer 106 formed from the final slurry can be compressed (e.g., using a calendering apparatus) before or after being applied to the electrode 100. The slurry can be partially or completely dried (e.g., by applying heat, vacuum or a combination thereof) prior to or during the compression process. For example, in some embodiments, the active layer may be compressed to a final thickness (e.g., in the direction normal to the current collector layer 102) of less than 90%, 80%, 70%, 50%, 40%, 30%, 20%, 10% or less of its pre-compression thickness.

When a partially dried layer is formed during a coating or compression process, the layer can be subsequently fully dried, (e.g., by applying heat, vacuum or a combination thereof). In some embodiments, substantially all of the solvent is removed from the active layer 106.

Solvents used in formation of the slurries can be recovered and recycled into the slurry-making process.

The active layer 106 can be compressed, e.g., to break some of the constituent high aspect ratio carbon elements or other carbonaceous material to increase the surface area of the respective layer. This compression treatment can increase one or more of adhesion between the layers, ion transport rate within the layers, and the surface area of the layers. In various embodiments, compression can be applied before or after the respective layer is applied to or formed on the electrode 100.

Where calendering is used to compress active layer 106, the calendering apparatus may be set with a gap spacing equal to less than 90%, 80%, 70%, 50%, 40%, 30%, 20%, 10% or less of the layer’s pre-compression thickness (e.g., set to about 33% of the layer’s pre-compression thickness). The calender rolls can be configured to provide suitable pressure, e.g., greater than 1 ton per cm of roll length, greater than 1.5 ton per cm of roll length, greater than 2.0 ton per cm of roll length, greater than 2.5 ton per cm of roll length, or more. The post compression active layer can have a density in the range of 1 g/cc to 10 g/cc, or any subrange thereof such as 2.0 g/cc to 4.0 g /cc. It is to be noted that the cathode active layer has a density of 2 to 4 g/cc. The anode active layer generally has a density of 1.0 to 1.8 g/cc. The calendering process can be carried out at a temperature in the range of 20° C. to 140° C. or any subrange thereof. In some embodiments active layer 106 may be pre-heated prior to calendering, e.g., at a temperature in the range of 20° C. to 100° C. or any subrange thereof.

The process 300 of the FIG. 2B may include any of the following features (individually or in any suitable combination):

The initial slurry has a solid content in the range of 0.1% to 20.0% (or any subrange thereof) by weight and/or the final slurry has a solid content in the range of 10.0% to 80% (or any subrange thereof) by weight.

As noted, a scaffold or matrix of the electrically conductive and binder can hold the active material particles together to form a cohesive layer that is also strongly attached to the metallic current collector. Such active material structure can be created during slurry preparation and subsequently in a roll to roll (“R2R”) coating and drying process. One of the main advantages of this technology is its scalability and “drop-in” nature because various embodiments are compatible with conventional electrode manufacturing processes.

The matrix can be formed during a slurry preparation using the techniques described herein: high aspect ratio carbon materials are properly dispersed and as desired chemically functionalized using, e.g., as described above with reference to process 200 and 300 of FIGS. 2A and 2B. The chemical functionalization is designed to form an organized self-assembled structure with the surface of active material particles, e.g., NMC particles for use in a cathode (detailed below) or silicon particles (“Si”) or Silicon Oxide (“SiOx”) particles in the case of an anode. The so formed slurry may be based on water and/or alcohol solvents for cathodes and water for anodes, and such solvents are very easily evaporated and handled during the manufacturing process. Electrostatic interactions promote the self-organized structure in the slurry, and after the drying process the bonding between the so formed carbon matrix with active material particles and the surface of the current collector is promoted by the surface treatment (e.g., functional groups on the matrix) as well as the strong entanglement of the active material in the carbon matrix.

The mechanical properties of the electrodes can be modified depending on the application, and the mass loading requirements by tuning the surface functionalization vs. entanglement effect.

After coating and drying, the electrodes can undergo a calendering step to control the density and porosity of the active material. In NMC cathode electrodes, densities of >=3.5 g/cc or more and 20% porosity or more can be achieved. Depending on mass loading and lithium ion battery cell requirements the porosity can be optimized. For silicon oxide or silicon based anodes, the porosity can be specifically controlled to accommodate active material expansion during the lithiation process.

The teachings herein may provide a reduction in $/kWh of up to 20%. By using water, alcohol or mixed water/alcohol as the solvents, these solvents are easily evaporated, the electrode production throughput can be higher, and more importantly, the energy consumption from the long driers can be significantly reduced. The conventional recovery systems needed when NMP or similar compounds are used as the solvent are also much simplified when water, alcohol or combinations thereof are used.

The teachings herein provide an active layer having a 3D matrix that can dramatically boosts electrode conductivity by a factor of 10X to 100X compared to electrodes using conventional binders such as PVDF, which enables fast charging at a battery level. Thick electrode coatings in cathode up to 150 um per side (or more) of current collector are possible with this technology. The solvents used in the slurry in combination with a strong 3D carbon matrix are designed to achieve thick wet coatings without cracking during the drying step. Thick cathodes with high capacity anodes enable a substantial jump in energy density reaching 400 Wh/kg or more.

### Cathode

The cathode comprises one or more polymeric binders (cathode polymeric binders), one or more active materials and an electrically conductive material. The one or more polymeric binders, one or more active materials and the electrically conductive material are blended with a solvent to form a cathode mixture. The cathode mixture is then disposed on a current collector (typically a metal) and dried to form a solid cathode active layer.

The cathode polymeric binders (used in the cathode) include a first cathode polymeric binder that includes a polyamide. Polyamides are detailed above and will not be detailed once again in the interests of brevity.

The cathode polymeric binder is present in an amount of 0.1 to 0.4 wt%, preferably 0.15 to 0.375 wt%, based on the weight of the cathode mixture (which includes the cathode polymeric binders (the first and second cathode polymeric binders), the cathode active material, the cathode conductive material and the solvent). The cathode polymeric binder is present in the cathode active layer in an amount of 0.2 to 0.5 wt%, preferably 0.25 to 0.45 wt%, based on the total weight of the cathode active layer.

### Cathode Active Materials

The cathode active material can comprise a lithium cobalt oxide (LCO, sometimes called “lithium cobaltate” or “lithium cobaltite”). Examples of LCO formulations include LiCoO₂; lithium nickel manganese cobalt oxide (NMC, with a variant formula of LiNiMnCo); lithium manganese oxide (LMO with variant formulas of LiMn₂O₄, Li₂MnO₃ or the like, or a combination thereof); lithium titanate oxide (LTO, with one variant formula being Li₄Ti₅O₁₂); lithium iron phosphate oxide (LFP, with one variant formula being LiFePO₄), lithium nickel cobalt aluminum oxide (and variants thereof as NCA) as well as other similar other materials. Other variants of the foregoing may be included.

In an embodiment, the cathode active material may comprise NMC, NCA, NCMA or a combination thereof.

Where NMC is used as a cathode active material, a nickel rich NMC may be used. For example, the variant of NMC may be LiNiₓMn_{y}Co_{(1-x-y)}, where x is equal to or greater than about 0.7, 0.75, 0.80, 0.85 or more, y is equal to or greater than 0.1, 0.15, 0.2 or 0.25, and x+y is less than 1. For example, NMC811 may be used where x is about 0.8 and y is about 0.1. Alternatively, the cathode active material can include oxides of lithium nickel manganese cobalt (LiNiₓMn_{y}Co_{z}O₂). Variants of this formula that may be used in the active material layer include NMC 111 (detailed below), NMC532 (LiNi_{0.5}Mn_{0.5}Co_{0.2}O₂), NMC622 (LiNi_{0.6}Mn_{0.2}Co_{0.2}O₂), or a combination thereof.

In an embodiment, NMC91 may be used as a cathode active material. NMC91 comprises 91 mole percent or more of nickel. An example of NMC91 is LiNi_{0.91}Co_{0.06}Mn_{0.03}O₂. Li[Ni_{1-x-y}CoₓAl_{y}]O₂ (NCA) may also be used as the cathode active material. An example of NCA is NCA89.

In yet another embodiment, the cathode active material may be a NCMA material. An example of a NCMA is Li[Ni_{0.89}Co_{0.05}Mn_{0.05}Al_{0.01}]O₂ also referred to as NCMA89.

In an embodiment, the cathode active material may also include a nickel-rich combination of nickel, manganese, and cobalt. Lithium-Nickel-Manganese-Cobalt-Oxide (LiNiMnCoO₂), abbreviated as NMC delivers strong overall performance, excellent specific energy, and the lowest self-heating rate of all mainstream cathode powders. The NMC powder may comprise nickel in an amount of 20 to 40 wt%, manganese in an amount of 20 to 40 wt% and cobalt in an amount of 20 to 40 wt%, based on a total weight of the NMC blend. While the term “NMC powder” can refer to a variety of blends, it is desirable to use a blend that comprises 33 wt% nickel, 33 wt% manganese and 33 wt% cobalt. This blend, sometimes referred to as 1-1-1 (NMC 111) is useful for applications that use frequent cycling (automotive, energy storage) due to the reduced material cost resulting from lower cobalt content a nickel-rich combination of nickel, manganese, and cobalt (NMC). The NMC powder may comprise nickel in an amount of 20 to 40 wt%, manganese in an amount of 20 to 40 wt% and cobalt in an amount of 20 to 40 wt%, based on a total weight of the NMC blend. While the term “NMC powder” can refer to a variety of blends, it is desirable to use a blend that comprises 33 wt% nickel, 33 wt% manganese and 33 wt% cobalt. This blend, sometimes referred to as 1-1-1 is useful for applications that use frequent cycling (automotive, energy storage) due to the reduced material cost resulting from lower cobalt content. Lithium-Nickel-Manganese-Cobalt-Oxide (LiNiMnCoO2), delivers strong overall performance, excellent specific energy, and the lowest self-heating rate of all mainstream cathode powders. Lithium-rich NCM materials, such as 424, and 523, manufactured by BASF may also be used to as a cathode active material.

In general, the addition of increased loading of active materials to the cathode (measured as a function of the total weight of the cathode) produces increased levels of areal capacity and specific energy in the cathode.

As noted above, the cathode active material can be contained or housed in the network of high aspect ratio electrically conductive materials present in the cathode active layer. The cathode active material can be present in the mixture used to form the cathode in amount of 90 to 99 wt%, preferably 96 to 98.5 wt%, based on a total weight of the cathode mixture (the mixture used to manufacture the cathode active layer which contains the cathode binder material, the cathode active material, the cathode electrically conducting material and the solvent). The cathode active material is present in the cathode active layer (which is devoid of the solvent) in an amount of 95 to 98.5 wt%, based on a total weight of the cathode active layer.

### Manufacturing of the Cathode Active Layer

The cathode active layer is disposed on a current collector. The cathode active layer is manufactured in a manner similar to the anode active layer. The cathode binder, the cathode active material and the cathode electrically conducting materials are mixed with a solvent to form a slurry. The slurry is disposed on the cathode current collector. The solvent is evaporated and the cathode current collector may be subjected to further finishing operations in a roll mill to produce the cathode, which then may be used in an energy storage device as detailed below.

### Summary of Cathode

In an embodiment, a cathode comprises an active layer comprising a network of high aspect ratio carbon elements defining void spaces within the network; a plurality of electrode active material particles disposed in the void spaces within the network; and a polymeric additive, the polymeric additive being at least one of (i) selected from a family of polyamides, or (ii) a modified polyamide or derivative of a polyamide.

The cathode comprises a network of high aspect ratio carbon elements comprises a first set of carbon nanotubes, wherein the first set of carbon nanotubes comprise a plurality of first carbon nanotubes or a plurality of bundles of first carbon nanotubes; and a second set of carbon nanotubes, wherein the second set of carbon nanotubes comprise a plurality of second carbon nanotubes or a plurality of bundles of second carbon nanotubes; and the second set of carbon nanotubes has one or more properties different from the first set of carbon nanotubes.

The first set of carbon nanotubes comprises multi-wall nanotubes. The second set of carbon nanotubes comprises single wall nanotubes. In an embodiment, the first set of carbon nanotubes comprises multi-wall carbon nanotubes; the second set of carbon nanotubes comprises single-wall carbon nanotubes; and a ratio of an amount by weight of the first set of carbon nanotubes to the second set of carbon nanotubes is about 2:1.

In an embodiment, the network of high aspect ratio carbon elements comprises a set of multi-wall carbon nanotubes. Some of the multiwall carbon nanotubes are branched, interdigitated, entangled and/or share common walls. The active layer comprises 0.2 to 2 wt% of multi-wall carbon nanotubes, or 0.25 to 1.5 wt% of multi-wall carbon nanotubes.

In an embodiment, an energy storage device comprises an electrolyte; an anode and a cathode, wherein when wetted with the electrolyte the multi-wall nanotubes (the first set of carbon nanotubes) of the cathode active layer swell more than the single-wall carbon nanotubes (the second set of carbon nanotubes).

In an embodiment, the multi-wall carbon nanotubes of the cathode active layer comprise an average diameter of between 6 nm and 10 nm, or 6 nm to 15 nm; an average wall thickness of between 6 nm and 7 nm; and an average length of about 16 micrometer. In an embodiment, in the cathode active layer can comprise single-wall carbon nanotubes having an average diameter of between 1 nm and 5 nm and an average length of greater than or equal to about 5 micrometers up to about 200 micrometers. In an embodiment, the cathode active layer can comprise single-wall carbon nanotubes having an average diameter of between 2 nm and 4 nm and an average length of greater than or equal to about 6 micrometers up to about 8 micrometers. The single-wall carbon nanotubes comprise on average 1 or 2 layers of walls.

In an embodiment, the carbon nanotubes used in the cathode active layer experience an increase in average thickness (increase in diameter) of less than 10% when wetted with an electrolyte. In an embodiment, the first average aspect ratio of the first set of carbon nanotubes is larger than a second average aspect ratio of the second set of carbon nanotubes. In another embodiment, the network of high aspect ratio carbon elements comprises a plurality of multi-wall carbon nanotubes; and a distribution of lengths of the plurality of multi-wall carbon nanotubes is skewed towards a nominal length of a multi-wall carbon nanotube, wherein the nominal length of the multi-wall carbon nanotube is at least 15 micrometers.

In an embodiment, the network of high aspect ratio carbon elements comprises a plurality of multi-wall carbon nanotubes; and at least 50% of the plurality of multi-wall carbon nanotubes have a length greater than 8 micrometers, preferably greater than 12 micrometers.

In an embodiment, an average aspect ratio of the first set of carbon nanotubes is at least 100, preferably between 200 and 1000. In an embodiment, the network of high aspect ratio carbon elements comprise a set of multi-wall carbon nanotubes that comprise a plurality of multi-wall carbon nanotubes; and the plurality of multi-wall carbon nanotubes have at least 5 layers of walls, preferably at least 6 layers of walls, and more preferably at least 7 layers of walls.

In another embodiment, the high aspect ratio carbon elements used in the cathode active layer comprise at least one material selected from the group consisting of: carbon nanostructures, fragments of carbon nanostructures, and fractured multi-wall carbon nanotubes.

In an embodiment, the cathode active layer comprises a polymeric binder that comprises a nylon (i.e., a polyamide). In an exemplary embodiment, the polyamide is a water soluble polyamide, an alcohol soluble polyamide, or a combination thereof (i.e., soluble in a combination of water and alcohol). The cathode active layer does not include a polymeric material that is non-soluble in water or an alcohol. In other words, the cathode active layer does not contain a polyamide or any other polymeric binder that is not water soluble.

The polyamide has a molecular weight greater than 200 g/mol, preferably greater than 500,000 g/mole, preferably greater than 1,000,000 g/mole, and more preferably 500,000 g/mole to 1,500,000 g//mole.

In an embodiment, the cathode active layer comprises at least 0.5 wt%, preferably 0.5 to 1.5 wt% of the polymeric additive. The weight percent is based on a total weight of the active layer.

In an embodiment, the cathode active layer has an average thickness of 20 to 100 micrometers, preferably 30 to 80 micrometers.

In an embodiment, the active material particles present in the active layer comprise at least one of lithium iron phosphate, lithium metal oxide, lithium-sulfur, lithium-cobalt-oxide, lithium-nickel-manganese-cobalt-oxide, lithium-nickel-cobalt-aluminum-oxide, lithium-nickel-cobalt-manganese-aluminum-oxide, or a combination thereof.

In an embodiment, the cathode active material comprises particles of at least one electrode active material selected from the group consisting of LiCoO₂, LiNiO₂, LiMn₂O₄, LiCoPO₄, LiFePO₄, LiNiMhCoO₂, and LiNi_{1-x-y-z}CoₓM1_{y}M2_{z}O_{z} (wherein M1 and M2 are each independently selected from the group consisting of Al, Ni, Co, Fe, Mn, V, Cr, Ti, W, Ta, Mg and Mo, and x, y and z represent the atomic fractions of the corresponding constituent elements of the oxide and satisfy the relations of 0≦x<0.5, 0≦y<0.5, 0≦z<0.5). The active layer contains at least 96 wt%, preferably 96.0 wt% to 98.5 wt% of the active material particles.

In an embodiment, the cathode active layer comprises about 25% of dispersant by weight.

In an embodiment, the cathode active layer comprises a surface treatment on the surface of the high aspect ratio carbon elements which promotes adhesion between the high aspect ratio carbon elements and the active material particles. In an embodiment, the surface treatment comprises a material which is soluble in a solvent having a boiling point less than 202° C., preferably less than 185° C. In an embodiment, the surface treatment comprises a surfactant layer; where the surfactant layer is bonded to the high aspect ratio carbon elements and comprises a plurality of surfactant elements each having a hydrophobic end and a hydrophilic end, wherein the hydrophobic end is disposed proximal to a surface comprising one of the carbon elements and the hydrophilic end is disposed distal to said surface that comprises one of the carbon elements.

In an embodiment, the surface treatment comprises the polymeric additive (the polyamide). In another embodiment, the polymeric additive is a polymeric binder. The polymeric additive is at least partially disposed in at least one void space defined by the network of high aspect ratio carbon elements. The polymeric additive has a specific gravity of at greater than 1.135 g/cm³, preferably greater than 1.20 g/cm³. The polymeric additive has a specific heat of at greater than 2.0 J/g°C at 23° C., preferably greater than 2.2 J/g°C at 23° C. and more preferably greater than 2.4 J/g°C at 23° C. The polymeric additive has a tensile strength of less than 70 MPa, preferably less than 50 MPa, preferably less than 25 MPa, preferably less than 10 MPa, preferably less than 7.5 MPa as measured when the polymer additive is dry. The polymeric additive has a tensile strength of between 5 and 6 MPa as measured when the polymer additive is dry.

The polymeric additive has an elongation at yield of greater than 5%, preferably greater than 10%, preferably greater than 20% and more preferably greater than 30% as measured when the polymer additive is dry. The tensile strength and elongation at yield is measured as per ASTM D 638.

The polymeric additive has a glass transition temperature of less than 0° C., preferably less than -10° C., preferably less than -25° C., preferably less than -30° C., preferably less than -45° C., when measured using differential scanning calorimetry (DSC) at temperature rate change of 10° C./minute. The polymeric additive has a 5% weight reduction temperature of between 375° C. and 400° C.

The polymeric additive exhibits gelling when a mixture of the polymeric additive and ethyl cellosolve is cooled. The polymeric additive is completely soluble in each of water, ethylene glycol, benzyl alcohol, acetic acid, N-methylpyrollidone and isobutanol.

In an embodiment, an aqueous solution of the polymeric additive and at least one of water and alcohol exhibits a viscosity of at least 60 Pa ·s at a concentration of about 50% by weight of polymeric additive. In an embodiment, a mixture of the polymeric additive and a water soluble polymer forms a transparent mixture.

The active layer does not include a polymeric material that is non-soluble in water or an alcohol.

In an embodiment, an energy storage device (which may be an ultracapacitor or battery) comprises an anode; an electrolyte; and a cathode, comprising a cathode active layer comprising a network of high aspect ratio carbon elements defining void spaces within the network; a plurality of electrode active material particles disposed in the void spaces within the network; and a polymeric additive the polymeric additive being at least one of (i) selected from a family of polyamides, or (ii) a modified polyamide or derivative of a polyamide.

In another embodiment, an electrode comprises an active layer comprising a network of high aspect ratio carbon elements defining void spaces within the network, wherein the network of high aspect ratio carbon elements comprises at least one material selected from the group consisting of: multi-wall carbon nanostructures, multi-wall carbon nanotubes, fragments of multi-wall carbon nanostructures, and fractured multi-wall carbon nanotubes; a plurality of electrode active material particles disposed in the void spaces within the network; and a polymeric additive, the polymeric additive being a polyamide that is soluble in water or an alcohol.

In another embodiment, an electrode, comprises an active layer comprising a network of high aspect ratio carbon elements defining void spaces within the network; a plurality of electrode active material particles disposed in the void spaces within the network; and a polymeric additive, the polymeric additive being a polyamide that is soluble in water or an alcohol, wherein the network of high aspect ratio carbon elements form one or more highly electrically conductive pathways; the network of high aspect ratio carbon elements comprises multi-wall carbon nanotubes; the network of high aspect ratio carbon elements provides mechanical support for at least part of plurality of electrode active material particles; and the polymeric additive providing support for at least part of the plurality of electrode active material particles.

### Energy Storage Device

Once the electrode 100 has been assembled, the electrode 100 may be used to assemble the energy storage device. Assembly of the energy storage device may follow conventional steps used for assembling electrodes with separators and placement within a housing such as a canister or pouch, and further may include additional steps for electrolyte addition and sealing of the housing.

One exemplary embodiment includes a Li-ion battery energy storage devices in a pouch cell format that combines Ni-rich NMC active material in the cathodes and SiOx and graphite blend active material in the anodes, where both anodes and cathodes are made using a 3D carbon matrix process as described herein.

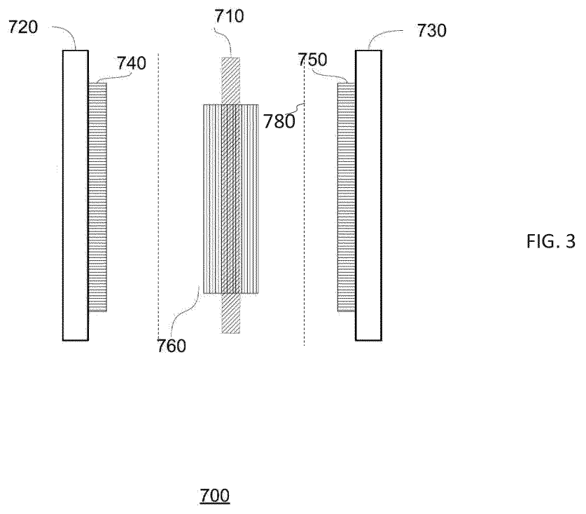

A schematic of the electrode arrangement one example of pouch cell devices is shown in FIG. 3. As shown, cathode active layers 760 (e.g., active layers according to various embodiments disclosed herein) on opposing sides of a current collector 710 (e.g., an aluminum foil current collector) to from a double sided cathode disposed between two single sided anodes. The single sided anodes each have an anode layer 740 or 750 (e.g., an active layer comprising a network of carbon elements such as disclosed herein) disposed on a current collector 720 or 730 (e.g., a copper current collector). The electrodes are be separated by permeable separator material 780 wetted with electrolyte (not shown). The arrangement can be housed in a pouch cell of the type well known in the art.

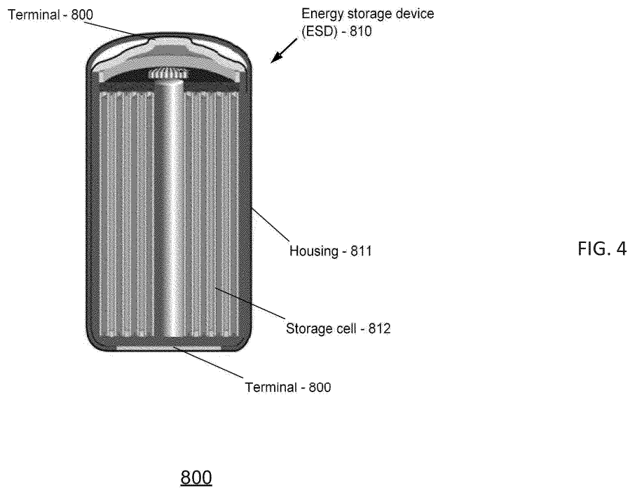

In FIG. 4, a cross section of an energy storage device (ESD) 810 is shown. The energy storage device (ESD) 810 includes a housing 811. The housing 811 has two terminals 800 disposed on an exterior thereof. The terminals 800 provide for internal electrical connection to a storage cell 812 contained within the housing 811 and for external electrical connection to an external device such as a load or charging device (not shown). The energy storage devices disclosed herein may be batteries, capacitors, ultracapacitors, or the like.

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An anode, comprising:
an active layer comprising:
a network of high aspect ratio carbon elements defining void spaces within the network;
a plurality of electrode active material particles disposed in the void spaces within the network, wherein the active material particles comprises silicon; and
a polymeric additive, the polymeric additive being at least one of (i) selected from a family of polyamides, or (ii) a modified polyamide or derivative of a polyamide.

2. The electrode of claim 1, wherein the silicon comprised in the electrode active material particles is in the form of SiO.

3. The electrode of claim 1, wherein the silicon comprised in the electrode active material is micro-silicon.

4. The electrode of claim 1, wherein the silicon comprised in the comprised in the electrode active material is greater than fifty percent of the active layer by weight.

5. The electrode of claim 1, wherein the silicon comprised in the comprised in the electrode active material is at least eighty percent of the active layer by weight.

6. The electrode of claim 1, wherein:
the network of high aspect ratio carbon elements comprises a mesh of carbon nanotubes; and
the mesh of carbon nanotubes maintains electrical connection among at least a subset of the carbon nanotubes comprised in the mesh during expansion of the Silicon.

7. The electrode of claim 1, wherein:
the network of high aspect ratio carbon elements comprises a mesh of carbon nanotubes; and
the mesh of carbon nanotubes maintains electrical connection among at least a subset of the carbon nanotubes comprised in the mesh during a charging and discharging of a battery in which the electrode is comprised.

8. The electrode of claim 1, wherein the network of high aspect ratio carbon elements comprises:
a first set of carbon nanotubes, wherein the first set of carbon nanotubes comprise a plurality of first carbon nanotubes or a plurality of bundles of first carbon nanotubes; and
a second set of carbon nanotubes, wherein:
the second set of carbon nanotubes comprise a plurality of second carbon nanotubes or a plurality of bundles of second carbon nanotubes; and
the second set of carbon nanotubes has one or more properties different from the first set of carbon nanotubes.

9. The electrode of claim 8, wherein the first set of carbon nanotubes comprises multi-wall nanotubes.

10. The electrode of claim 8, wherein the second set of carbon nanotubes comprises single wall nanotubes.

11. A cathode, comprising:
an active layer comprising:
a network of high aspect ratio carbon elements defining void spaces within the network;
a plurality of electrode active material particles disposed in the void spaces within the network; and
a polymeric additive, the polymeric additive being at least one of (i) selected from a family of polyamides, or (ii) a modified polyamide or derivative of a polyamide.

12. The electrode of claim 11, wherein network of high aspect ratio carbon elements comprises:
a first set of carbon nanotubes, wherein the first set of carbon nanotubes comprise a plurality of first carbon nanotubes or a plurality of bundles of first carbon nanotubes; and
a second set of carbon nanotubes, wherein:
the second set of carbon nanotubes comprise a plurality of second carbon nanotubes or a plurality of bundles of second carbon nanotubes; and
the second set of carbon nanotubes has one or more properties different from the first set of carbon nanotubes.

13. The electrode of claim 12, wherein the first set of carbon nanotubes comprises multi-wall nanotubes.

14. The electrode of claim 12, wherein the second set of carbon nanotubes comprises single wall nanotubes.

15. The electrode of claim 12, wherein:
the first set of carbon nanotubes comprises multi-wall carbon nanotubes;
the second set of carbon nanotubes comprises single-wall carbon nanotubes; and
a ratio of an amount by weight of the first set of carbon nanotubes to the second set of carbon nanotubes is about 2:1.

16. The electrode of claim 11, wherein the network of high aspect ratio carbon elements comprises a set of multi-wall carbon nanotubes.

17. The electrode of claim 16, wherein the active layer comprises 0.2-2% of multi-wall carbon nanotubes by weight, or 0.25-1.5% of multi-wall carbon nanotubes by weight.

18. The electrode of claim 16, wherein the multi-wall carbon nanotubes are branched carbon nanotubes.

19. The electrode of claim 16, wherein the active layer comprises 0.25-1.5% of multi-wall carbon nanotubes by weight.

20. The electrode of claim 16, wherein the multi-wall carbon nanotubes are branched, interdigitated, entangled and/or share common walls.

21. An energy storage device comprising:
an electrolyte; and the electrode of claim 12, wherein when wetted with the electrolyte the multi-wall nanotubes contained in the first set of carbon nanotubes swell more than the single-wall carbon nanotubes contained in the second set of carbon nanotubes.
